(19) United States
(12) Patent Application Publication
(10) Pub. No.: US 2026/0128206 A1
(43) Pub. Date: May 7, 2026

(54) MULTILAYER DEVICE AND SUBSTRATE MODULE

(71) Applicant: Panasonic Intellectual Property Management Co., Ltd., Osaka (JP)

(72) Inventors: TOMOHIDE KAMIYAMA, Osaka (JP); YOSHIYUKI SAITO, Tokyo (JP)

(21) Appl. No.: 19/121,831

(22) PCT Filed: Nov. 6, 2023
(86) PCT No.: PCT/JP2023/039862

§ 371 Date: Apr. 17, 2025

(30) Foreign Application Priority Data
Nov. 10, 2022 (JP) 2022-180631

(51) Int. Cl. H01F 27/28; H01F 27/24; H01F 27/29

(52) U.S. Cl. CPC H01F 27/2804; H01F 27/24; H01F 27/29; H01F 2027/2809

(57) ABSTRACT

A multilayer device includes a dielectric body, a signal line disposed inside the dielectric body, planar electrodes disposed inside the dielectric body and along a direction, lead-out electrodes disposed either inside the dielectric body or on an outer surface of the dielectric body, connecting electrodes disposed inside the dielectric body and connecting the planar electrodes to the lead-out electrodes, signal terminals connected to the signal line, and ground terminals connected to the lead-out electrodes and configured to have a ground potential. Plural structures each including one of the planar electrodes, one of the connecting electrodes, one of the lead-out electrodes, and one of the ground terminals are disconnected from one other and separated from one another inside the dielectric body and on the outer surface of the dielectric body.

### TECHNICAL FIELD

The present disclosure relates to a multilayer device and a substrate module including the multilayer device.

### BACKGROUND ART

Functional substrates configured to control passing characteristics of high-speed digital signals and high-frequency signals (hereinafter referred to as high-speed, high-frequency signals) have been know. As an example of these functional substrates, PTL 1 discloses a functional substrate including a conductor configured to function as a ground (ground electrode) and mushroom structures each including a conductive element (a planar electrode) and a through-via (a connecting electrode). The functional substrate has a structure in which the mushroom structures are periodically arranged, and can inhibit passing of signals of specific frequencies out of high-speed, high-frequency signals.

### CITATION LIST

### Patent Literature

PTL 1: International Publication WO2011/111311

### SUMMARY OF INVENTION

However, although being capable of blocking passing of signals of particular frequencies out of high-speed, high-frequency signals, the conventional functional substrate does not provide a stopband that blocks passing of high-speed, high-frequency signals in accordance with requirements for a multilayer device.

A multilayer device according to an aspect of the present disclosure includes a dielectric body, a signal line disposed inside the dielectric body such that a part of the signal line is exposed from an outer surface of the dielectric body, planar electrodes disposed inside the dielectric body and along a first direction, lead-out electrodes disposed either inside the dielectric body or on the outer surface of the dielectric body such that at least a part of the lead-out electrodes is exposed from the outer surface of the dielectric body, connecting electrodes disposed inside the dielectric body and connecting the planar electrodes to the lead-out electrodes, signal terminals disposed on the outer surface of the dielectric body and connected to the signal line, and ground terminals disposed on the outer surface of the dielectric body and connected to the lead-out electrodes such that the ground terminals are configured to have a ground potential. The planar electrodes, the connecting electrodes, the lead-out electrodes, and the ground terminals constitute structures. Each of the structures includes a corresponding one planar electrode out of the planar electrodes, a corresponding one connecting electrode out of the connecting electrodes, a corresponding one lead-out electrode out of the lead-out electrodes, and a corresponding one ground terminal out of the ground terminals. The structures are disconnected and separated from one another both inside the dielectric body and on the outer surface of the dielectric body.

A multilayer device according to an aspect of the present disclosure includes a dielectric body, a signal line disposed inside the dielectric body such that a part of the signal line is exposed from an outer surface of the dielectric body, planar electrodes disposed inside the dielectric body and along a direction, lead-out electrodes disposed either inside the dielectric body or on the outer surface of the dielectric body such that at least a part of each of the lead-out electrodes is exposed from the outer surface of the dielectric body, connecting electrodes disposed inside the dielectric body, signal terminals disposed on the outer surface of the dielectric body and connected to the signal line, and ground terminals disposed on the outer surface of the dielectric body and configured to have a ground potential. The planar electrodes are connected in one-to-one correspondence to the connecting electrodes. The connecting electrodes are connected in one-to-one correspondence to the lead-out electrodes. The lead-out electrodes are connected in one-to-one correspondence to the ground terminals.

A substrate module according to an aspect of the present disclosure includes the multilayer device described above.

The multilayer devices according to the present disclosure provides a stopband in accordance with a requirement.

### BRIEF DESCRIPTION OF DRAWINGS

FIG. 1 is a perspective view of a multilayer device.

FIG. 2 illustrates an equivalent circuit of the multilayer device shown in FIG. 1.

FIG. 3 is a perspective view of a multilayer device according to Exemplary Embodiment 1.

FIG. 4A illustrates a signal line, planar electrodes, connecting electrodes, and lead-out electrodes of the multilayer device according to Embodiment 1.

FIG. 4B illustrates the signal line, the planar electrodes, the connecting electrodes, and the lead-out electrodes visually extracted from the multilayer device according to Embodiment 1.

FIG. 5A is a plan view of the signal line and other parts of the multilayer device according to Embodiment 1 when viewed from above.

FIG. 5B is a cross-sectional view of the multilayer device according to Embodiment 1 along line VB-VB shown in FIG. 5A.

FIG. 5C is a bottom view of the multilayer device according to Embodiment 1.

FIG. 6 illustrates a substrate module including the multilayer device according to Embodiment 1.

FIG. 7 is a perspective view of a multilayer device according to Modified Example 1 of Embodiment 1.

FIG. 8 illustrates a signal line, planar electrodes, connecting electrodes, and lead-out electrodes of a multilayer device according to Modified Example 2 of Embodiment 1.

FIG. 9 illustrates a substrate module including the multilayer device according to Modified Example 2 of Embodiment 1.

FIG. 10 illustrates a signal line, planar electrodes, connecting electrodes, and lead-out electrodes of a multilayer device according to Modified Example 3 of Embodiment 1.

FIG. 11 is a perspective view of a multilayer device according to Modified Example 4 of Embodiment 1.

FIG. 12 illustrates a signal line, planar electrodes, connecting electrodes, and lead-out electrodes of the multilayer device according to Modified Example 4 of Embodiment 1.

FIG. 13 illustrates a signal line, planar electrodes, connecting electrodes, and lead-out electrodes of a multilayer device according to Modified Example 5 of Embodiment 1.

FIG. 14 is a perspective view of a multilayer device according to Exemplary Embodiment 2.

FIG. 15 illustrates a signal line, planar electrodes, connecting electrodes, and lead-out electrodes of the multilayer device according to Embodiment 2.

### DESCRIPTION OF EMBODIMENTS

### Knowledge for Reaching Present Disclosure

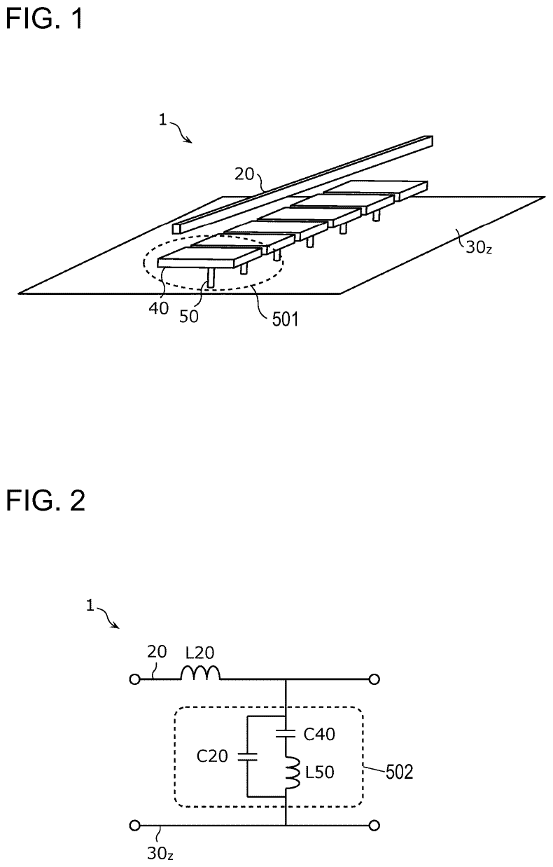

Knowledge for reaching the present disclosure will be described with reference to FIGS. 1 and 2.

FIG. 1 is a perspective view of multilayer device 1.

As shown in FIG. 1, multilayer device 1 includes signal line 20 configured to transmit high-speed, high-frequency signals, ground electrode 30z configured to have a ground potential, planar electrodes 40 arranged along signal line 20, and connecting electrodes 50 connecting ground electrode 30z to planar electrodes 40. Signal line 20, ground electrode 30z, planar electrodes 40, and connecting electrodes 50 are disposed either inside or on surfaces of a dielectric body. Connecting electrodes 50 are one example of via-electrodes.

Multilayer device 1 has a structure in which mushroom structures 501 each including planar electrode 40 and connecting electrode 50 are disposed with intervals sufficiently smaller than wavelengths of electromagnetic waves. This structure in which mushroom structures 501 are disposed at intervals sufficiently smaller than wavelengths of electromagnetic waves is called an Electromagnetic Band Gap (EBG) structure. Multilayer device 1 having the EBG structure may have negative values of an effective permittivity and a permeability in a medium.

FIG. 2 illustrates an equivalent circuit of multilayer device 1 shown in FIG. 1.

The equivalent circuit shown in FIG. 2 includes inductive component L20 of signal line 20 and parallel circuit 502 (parallel resonant circuit) disposed in a path connecting signal line 20 to ground electrode 30z. Parallel circuit 502 includes capacitive component C40 constituted by signal line 20 and planar electrode 40, inductive component L50 of connecting electrode 50, and capacitive component C20 constituted by signal line 20 and ground electrode 30z.

Multilayer device 1 includes mushroom structures 501 shown in FIG. 1 to control the admittance of parallel circuit 502 shown in FIG. 2 such that the permittivity has a negative value. In a band in which the permittivity is negative, high-speed, high-frequency signals cannot be propagated through the signal line, and thus, multilayer device 1 functions as a band-stop filter.

The multilayer device according to the present embodiment has the following configuration to provide a stopband which stops high-speed, high-frequency signals from passing through it, in accordance with required specifications.

Exemplary embodiments will be detailed below with reference to accompanying drawings.

Each embodiment described below illustrates a particular example of the present disclosure. The numerical values, shapes, materials, elements, the arrangement and connection of the elements, steps, and order of the steps shown in the following embodiments are mere examples, and therefore do not limit the scope of the present disclosure. Accordingly, among the elements in the following embodiments, those not recited in any of the independent claims are described as optional elements.

In the present specification, terms indicating relationships between elements such as “parallel”, terms indicating shapes of elements such as “rectangular parallelepiped”, and numerical ranges are expressions that include, in addition to their exact meanings, substantially equivalent ranges, including differences of approximately a few percent, for example.

The figures are schematic illustrations, appropriately emphasized, omitted, or adjusted in ratio to represent the present disclosure, are not necessarily precise depictions, and may differ from actual shapes, positional relationships, and ratios. In the figures, the same reference signs are used for elements that are substantially the same. Accordingly, duplicate descriptions may be omitted or simplified.

In the present specification, the terms “top surface” and “bottom surface” used with respect to the configuration of the multilayer device do not refer to the top surface (vertically upper surface) and the bottom surface (vertically lower surface) in terms of absolute spatial recognition, but are used as terms defined by the relative positional relationships between elements of the multilayer device.

### Exemplary Embodiment 1

### Configuration of Multilayer Device

A configuration of multilayer device 1A according to Exemplary Embodiment 1 will be described.

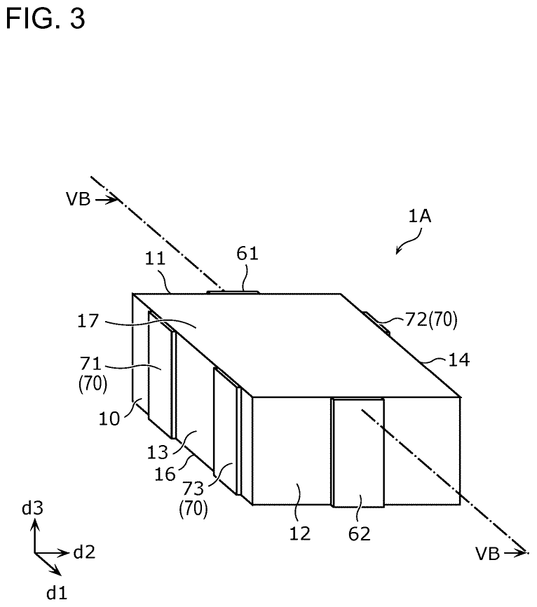

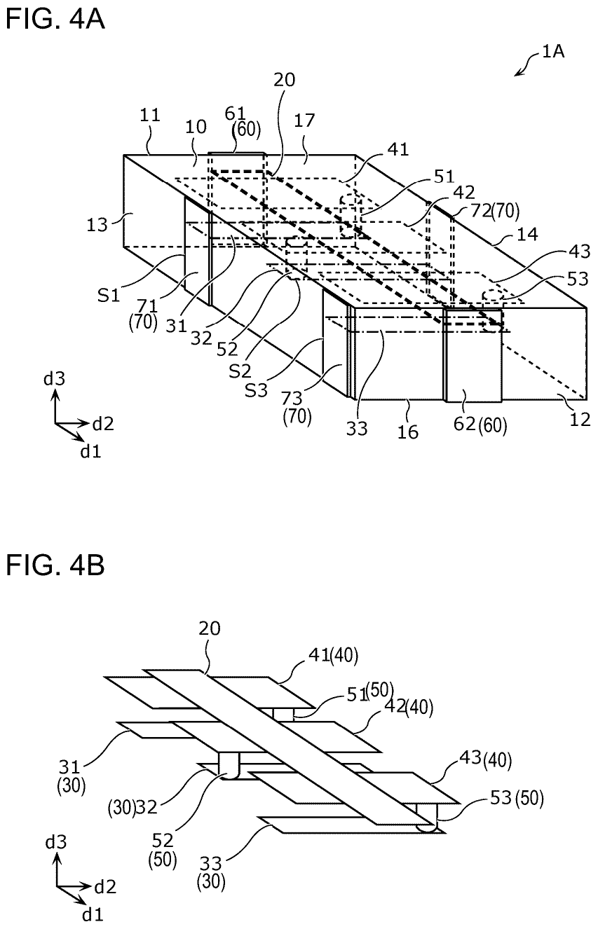

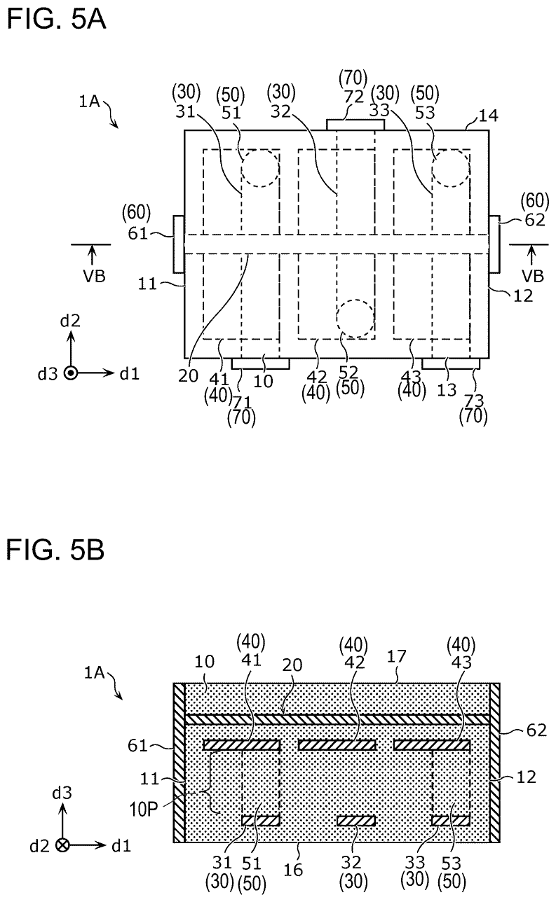

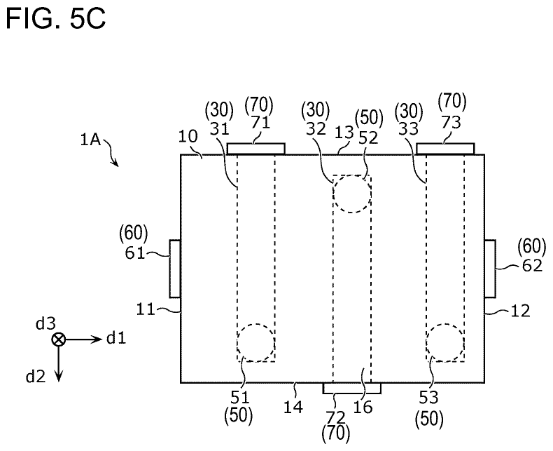

FIG. 3 is a perspective view of multilayer device 1A according to Embodiment 1. FIG. 4A illustrates signal line 20, planar electrodes 41, 42, and 43, connecting electrodes 51, 52, and 53, and lead-out electrodes 31, 32, and 33 of multilayer device 1A. FIG. 4B illustrates signal line 20, planar electrodes 41, 42, and 43, connecting electrodes 51, 52, and 53, and lead-out electrodes 31, 32, and 33 visually extracted from multilayer device 1A. FIG. 5A is a plan view of signal line 20 and other parts of multilayer device 1A when viewed from above. FIG. 5B is a cross-sectional view of multilayer device 1A along line VB-VB shown in FIG. 5A. FIG. 5C is a bottom view of multilayer device 1A.

Multilayer device 1A shown in FIGS. 3, 4A, 4B, and 5A-5C includes dielectric body 10, signal line 20, planar electrodes 41, 42, and 43, connecting electrodes 51, 52, and 53, and lead-out electrodes 31, 32, and 33. Multilayer device 1A further includes signal terminals 61 and 62 and ground terminals 71, 72, and 73. In FIG. 4A, signal line 20 is indicated by a thick dashed line, and lead-out electrodes 31, 32, and 33 are indicated by dashed and dotted lines. In FIG. 5C, the signal line and the planar electrodes are visually omitted from the figure.

In the following, some or all of planar electrodes 41-43 may be referred to as planar electrodes 40, some or all of connecting electrodes 51-53 may be referred to as connecting electrodes 50, and some or all of lead-out electrodes 31-33 may be referred to as lead-out electrodes 30. Some or all of signal terminals 61 and 62 may be referred to as signal terminals 60, and some or all of ground terminals 71 to 73 may be referred to as ground terminals 70.

Signal line 20, lead-out electrodes 30, planar electrodes 40, and connecting electrodes 50 are made of metal material, such as silver or copper. Signal line 20, lead-out electrodes 30, planar electrodes 40, and connecting electrodes 50 may be made of either the same material or the same materials in the same composition ratios or, alternatively, made of either different materials or the same materials in different composition ratios.

Dielectric body 10 is formed by, for example, stacking dielectric layers. Dielectric body 10 is made of, for example, dielectric material, such as low temperature co-fired ceramics (LTCC). Dielectric body 10 may be preferably made of material with high relative permittivity to reduce the size of multilayer device 1A. Dielectric body 10 is disposed between signal line 20, each of lead-out electrodes 30, and each of planar electrodes 40. Dielectric body 10 covers the outer surface of signal line 20 except for both end surfaces thereof, the outer surfaces of lead-out electrodes 30 except for one end surfaces (the other end surfaces to be described later) thereof, planar electrodes 40, and connecting electrodes 50.

Dielectric body 10 has a rectangular parallelepiped shape having bottom surface 16, top surface 17 facing away from bottom surface 16, side surfaces 11, 12, 13, and 14 connected to bottom surface 16 and top surface 17. Side surfaces 11-14 includes side surfaces 11 and 12 facing away from each other and side surfaces 13 and 14 perpendicular to both side surfaces 11 and 12. Bottom surface 16 and top surface 17 are parallel to each other. Side surfaces 11 and 12 are parallel to each other. Side surfaces 13 and 14 are parallel to each other. Edges (ridges) where the surfaces of the dielectric body 10 intersect with each other may be rounded.

The direction along which side surfaces 11 and 12 face away from each other is referred to as first direction d1. The direction along which side surfaces 13 and 14 face away from each other is referred to as second direction d2. The direction along which bottom surface 16 and top surface 17 face away from each other is referred to as third direction d3. Further, hereinafter, a negative side of first direction d1 may be referred to as “one side,” while the positive side opposite to the negative side may be referred to as “another side.”

Signal line 20 has a straight strip shape and is disposed along first direction d1. Signal line 20 is disposed inside dielectric body 10 such that both ends thereof, i.e. portions of signal line 20, are exposed from outer surfaces (side surfaces 11 and 12) of dielectric body 10. Signal line 20 is parallel to planar electrodes 40, and is disposed closer to top surface 17 than planar electrodes 40. Multilayer device 1A is mounted onto a substrate module, and high-speed, high-frequency signals are output from and input to signal line 20 via signal terminals 60.

Signal terminals 60 are disposed on side surfaces 11 and 12, i.e. outer surfaces of dielectric body 10. One signal terminal 61 out of two signal terminals 61 and 62 is disposed on side surface 11 while another signal terminal 62 out of two signal terminals 61 and 62 is disposed on side surface 12. One end of signal line 20 is connected to the one signal terminal 61. Another end of signal line 20 is connected to another signal terminal 62.

Each planar electrode 40 has a rectangular plane shape. The shape of planar electrode 40 is not limited to the rectangular shape, and may have a square, polygonal, circular, or elliptical shape. Planar electrodes 41, 42, and 43 are disposed at regular intervals in this order along first direction d1 from the input side to output side of signal line 20. Each of planar electrodes 41, 42, and 43 has the same shape, size, and area.

Each planar electrode 40 is disposed parallel to signal line 20. Each planar electrode 40 is disposed inside dielectric body 10 such that each of planer electrodes 40 is located between signal line 20 and a corresponding one of lead-out electrodes 30 in third direction d3. For example, the planar electrodes are disposed inside dielectric body 10 such that planar electrode 41 is located between signal line 20 and lead-out electrode 31, planar electrode 42 is located between signal line 20 and lead-out electrode 32, and planar electrode 43 is located between signal line 20 and lead-out electrode 33.

Each connecting electrodes 50 is a via-conductor having a circular columnar shape, and is disposed inside dielectric body 10. As shown in FIG. 5B, connecting electrodes 50 are via conductors that penetrate portions 10P of dielectric body 10 such that each portions 10P is located between corresponding one of planar electrodes 40 and a corresponding one of lead-out electrodes 30. Connecting electrodes 50 have a diameter of, e.g., 100 μm. Connecting electrodes 51, 52, and 53 are disposed in this order with regular intervals along first direction d1. Connecting electrodes 51, 52, and 53 have the same shape, size, and length. Connecting electrodes 51 to 53 are disposed along first direction d1 in one-to-one correspondence to both planar electrodes 41-43 and respective lead-out electrodes 30.

Each of connecting electrodes 50 penetrates a portion dielectric body 10 located between a corresponding one of planar electrodes 40 and a corresponding one of lead-out electrodes 30 so as to connect the corresponding one of planar electrodes 40 to the corresponding one of lead-out electrodes 30. For example, connecting electrode 51 connects planar electrode 41 to lead-out electrode 31. Connecting electrode 52 connects planar electrode 42 to lead-out electrode 32. Connecting electrode 53 connects planar electrode 43 to lead-out electrode 33.

As shown in FIG. 5A, each of connecting electrodes 50 is disposed at a corner of an outer peripheral end of a corresponding one of planar electrodes 40 when viewed in third direction d3 perpendicular to planar electrode 40. When viewed in the direction perpendicular to planar electrode 40, connecting electrode 50 does not overlap signal line 20, but overlaps both the outer peripheral end of planar electrode 40 in second direction d2 and an end portion of lead-out electrode 30 in second direction d2. Further, connecting electrodes 50 are disposed along first direction d1 in a zigzag pattern straddling signal line 20. Connecting electrode 51 is disposed closer to side surface 13 when viewed from signal line 20. Connecting electrode 52 is disposed closer to side surface 14 when viewed from signal line 20. Connecting electrode 53 is disposed closer to side surface 13 when viewed from signal line 20. That is, connecting electrodes 51, 52, and 53 are disposed in this order along first direction d1 so as to be alternately adjacent to side surfaces 13 and 14 which face away from each other.

Each lead-out electrode 30 is a strip shape extending along second direction d2. Each lead-out electrode 30 is parallel to planar electrode 40 and disposed closer to bottom surface 16 than planar electrode 40. Lead-out electrodes 31, 32, and 33 are disposed in this order with regular intervals along first direction d1.

The width (length in first direction d1) of lead-out electrodes 30 is equal to or larger than the thickness (length in first direction d1) of connecting electrodes 50, and is equal to or smaller than the length in first direction d1 of planar electrodes 40. The length (length in second direction d2) of lead-out electrodes 30 is larger than the length in second direction d2 of planar electrodes 40, and is smaller than the length in second direction d2 of multilayer device 1A. Each lead-out electrode 30 is led out not to a surface out of side surfaces 13 and 14 which is closer to corresponding connecting electrode 50 but to a surface out of side surfaces 13 and 14 which is farther from corresponding connecting electrode 50. Lead-out electrodes 30 have the same width (length in first direction d1), the same length in second direction d2, and the same thickness in third direction d3.

Lead-out electrodes 30 are disposed inside dielectric body 10 such that a part of each lead-out electrode 30 is exposed from the outer surface of dielectric body 10. Lead-out electrode 31 is disposed such that one end of lead-out electrode 31 is connected to connecting electrode 51, and that another end of lead-out electrode 31 contacts side surface 13 of dielectric body 10 and constitutes portion 31P exposed from dielectric body 10. Lead-out electrode 32 is disposed such that one end of lead-out electrode 32 is connected to connecting electrode 52, and that another end of lead-out electrode 32 contacts side surface 14 of dielectric body 10 and constitutes portion 32P exposed from dielectric body 10. Lead-out electrode 33 is disposed such that one end of lead-out electrode 33 is connected to connecting electrode 53, and that another end of lead-out electrode 33 contacts side surface 13 of dielectric body 10 and constitutes portion 33P exposed from dielectric body 10. Each lead-out electrode 30 thus extends from a location close to one side surface (14 or 13) out of two side surfaces 13 and 14 toward another side surface (13 or 14), and is connected to a corresponding one of ground terminals 70 at the other side surface (14 or 13).

Ground terminals 70 are disposed on the outer surface of dielectric body 10. Ground terminals 71, 72, and 73 are disposed on two side surfaces 13 and 14 out of four side surfaces 11-14. Ground terminals 71 to 73 are disposed on two side surfaces 13 and 14 different from side surfaces 11 and 12 on which signal terminals 60 are disposed. Each ground terminal 70 contacts bottom surface 16, extends from the bottom surface 16 along either side surface 13 or 14 toward top surface 17, and contacts top surface 17. Although one ground terminal 71, for example, is formed only on side surface 13, it may further extend to top surface 17 and bottom surface 16 of dielectric body 10 through the forming of a U-shape wraparound.

Ground terminals 71-73 are arranged along first direction d1 in a zigzag pattern straddling signal line 20. For example, ground terminals 71 and 73 are disposed on side surface 13 located on the opposite side to connecting electrodes 51 and 53 with respect to signal line 20. Ground terminal 72 is disposed on side surface 14 located on the opposite side of connecting electrode 52 with respect to signal line 20. Portion 31P, another end of lead-out electrode 31, is connected to ground terminal 71. Portion 32P, another end of lead-out electrode 32, is connected to ground terminal 72. Portion 33P, another end of lead-out electrode 33, is connected to ground terminal 73.

While multilayer device 1A is mounted onto a substrate module, ground terminals 71, 72, and 73 has a ground potential. Thus, lead-out electrodes 31, 32, and 33, connecting electrodes 51, 52, and 53, and planar electrodes 41, 42, and 43 that are electrically coupled to respective ground terminals 71, 72, and 73 also have the ground potential.

In accordance with the embodiment, planar electrodes 41, 42, and 43 are connected in one-to-one correspondence to connecting electrodes 51, 52, and 53. Connecting electrodes 51, 52, and 53 are connected in one-to-one correspondence to lead-out electrodes 31, 32, and 33. Lead-out electrodes 31, 32, and 33 are connected in one-to-one correspondence to ground terminals 71, 72, and 73. In other words, first structure S1 is composed of planar electrode 41, connecting electrode 51, lead-out electrode 31, and ground terminal 71. Second structure S2 is composed of planar electrode 42, connecting electrode 52, lead-out electrode 32, and ground terminal 72. Third structure S3 is composed of planar electrode 43, connecting electrode 53, lead-out electrode 33, and ground terminal 73. First structure S1, second structure S2, and third structure S3 are disconnected from one another and separated from one another. Structures S1, S2, and S3 are thus constituted by planar electrodes 41, 42, and 43, connecting electrodes 51, 52, and 53, lead-out electrodes 31, 32, and 33, and ground terminals 71, 72, and 73. Each of structures S1, S2, and S3 described above is composed of a corresponding one planar electrode 41, 42, or 43 out of multiple planar electrodes 41, 42, and 43, a corresponding one connecting electrode out of connecting electrodes 51, 52, and 53, a corresponding one lead-out electrode out of lead-out electrodes 31, 32, and 33, and a corresponding one ground terminal out of ground terminals 71, 72, and 73.

In accordance with the embodiment, a structure is constituted by the planar electrode, the connecting electrode, the lead-out electrode, and the ground terminal. Plural structures S1-S3 are disconnected from one another and separated from one another both inside dielectric body 10 and on the outer surface of dielectric body 10. Therefore, in the case where multilayer device 1A is mounted on a printed-circuit board, it is possible to provide inductance values in accordance with wirings on the printed-circuit board, with the wirings being connected to ground terminals 70. For example, increasing the length of a wiring on the printed-circuit board increases the inductance value generated by the wiring and the above-described structure, and decreasing the length of the wiring on the printed-circuit board reduces the inductance value generated by the wiring and the above-described structure. Changing the inductance values thus changes the value of individual inductive component L50 (see FIG. 2) generated by both the respective wirings on the printed-circuit board and the respective structures S1-S3, which results in a change in frequency of the stopband of multilayer device 1A. This configuration provides a stopband in accordance with required specifications. Further, it is possible to make broader the stopband of multilayer device 1A by changing the value of the individual inductive component L50 generated by both the respective wirings on the printed-circuit board and the respective plural structures S1-S3.

### Method for Manufacturing Multilayer Device

First, one or more layers of green sheets which do not have electrode patterns thereon are stacked to form a lower layer sheet. The green sheets are dielectric sheets to be a dielectric layer after sintering them. Next, a green sheet that has lead-out electrode patterns is stacked on the lower layer sheet. The lead-out electrode patterns are printed patterns to be lead-out electrodes 30 after sintering them. The lead-out electrode patterns are separated from each other on the green sheet.

Next, green sheets each having connecting electrode patterns thereon are stacked on the green sheet having the lead-out electrode patterns thereon. The connecting electrode patterns are printed patterns to be connecting electrodes 50 after sintering. The connecting electrode patterns are separated from each other on the green sheets.

Next, a green sheet having plural sets each being composed of a connecting electrode pattern and a planar electrode pattern is stacked on the thus-stacked green sheets. The planar electrode patterns are printed patterns to be planar electrodes 40 after sintering. The plural sets of the connecting electrode patterns and the planar electrode patterns are separated from one another on this green sheet with each set being composed of one connecting electrode pattern and one planar electrode pattern.

Next, a green sheet having a signal line pattern is stacked on the green sheet having the plural sets of the connecting electrode patterns and the planar electrode patterns. The signal line pattern is a printed pattern to be signal line 20 after sintering. Next, one or more green sheets without electrode patterns are stacked on the green sheet having the signal line pattern to form an upper layer sheet.

The thus-stacked sheets are pressed to form a mother stack. Next, the mother stack is cut into individual segments, followed by sintering the individual segments. Then, two signal terminals 60 and three ground terminals 70 are formed on the side surface of each of the sintered segments, thereby providing multilayer device 1A described above.

According to this method, the structures S1-S3 are separated from one another both inside dielectric body 10 and on the outer surface of dielectric body 10 while each of the structures includes the planar electrode, the connecting electrode, the lead-out electrode, and the ground terminal. The lead-out electrode patterns separated from one another are arranged to securely adhere the upper and lower green sheets to one another in a region between adjacent two lead-out electrode patterns. This configuration enhances interlayer adhesive in a region in which lead-out electrodes 30 are formed.

### Substrate Module

Substrate module 80 including multilayer device 1A according to the embodiment will be described. Substrate module 80 is a substrate to be built in, e.g., an electrical apparatus.

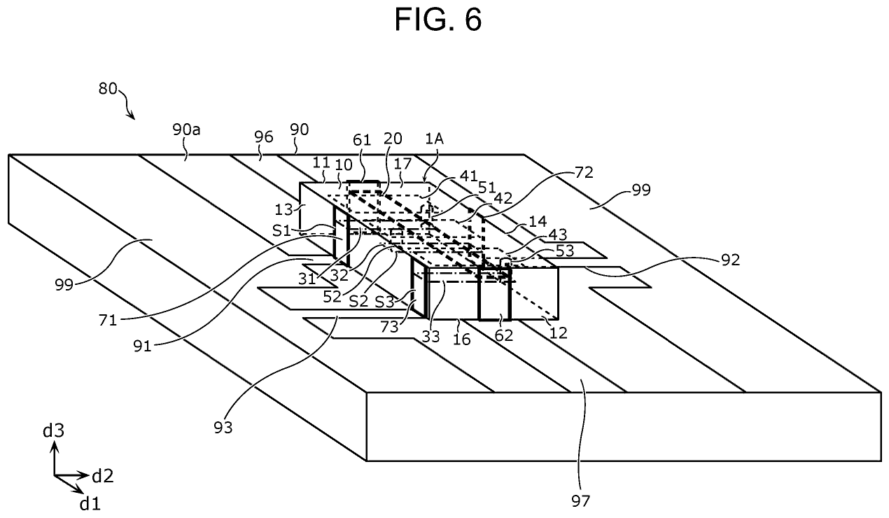

FIG. 6 illustrates substrate module 80 including multilayer device 1A according to the present embodiment.

As shown in FIG. 6, substrate module 80 includes multilayer device 1A and printed-circuit board 90. Substrate module 80 may further include another electronic component different from multilayer device 1A. In FIG. 6, land electrodes and a bonding agent, such as solder, which are disposed on printed-circuit board 90, are visually omitted from the figure.

Multilayer device 1A is mounted onto printed-circuit board 90 with the bonding agent, such as solder.

Wirings 96 and 97 for transmitting high-speed, high-frequency signals are disposed on mounting surface 90a of printed-circuit board 90. Wiring 96 extends toward side surface 11 of multilayer device 1A and is connected to signal terminal 61. Wiring 97 extends toward side surface 12 of multilayer device 1A and is connected to signal terminal 62.

Ground electrode 99 configured to have a ground potential and wirings 91, 92, and 93 connected to ground electrode 99 are disposed on mounting surface 90a of printed-circuit board 90. Ground electrode 99 is disposed away from multilayer device 1A with a predetermined space between ground electrode 99 and multilayer device 1A. In the case where a ground electrode is disposed on a back surface of printed-circuit board 90, ground electrode 99 disposed on a front surface may be connected to the ground electrode on the back surface through a via-electrode formed in printed-circuit board 90 in a thickness direction of printed-circuit board 90.

Each of wirings 91-93 extends linearly from ground electrode 99 toward either side surface 13 or 14 of multilayer device 1A, and is connected to a corresponding one of ground terminals 70.

For example, wiring 91 extends from ground electrode 99 toward side surface 13 of multilayer device 1A, and is connected to ground terminal 71. Wiring 92 extends from ground electrode 99 toward side surface 14 of multilayer device 1A, and is connected to ground terminal 72. Wiring 93 extends from ground electrode 99 toward side surface 13 of multilayer device 1A, and is connected to ground terminal 73.

Wirings 91-93 have the same width and thickness while having lengths different from one another. In this example, the length of wiring 91 is smaller than that of wiring 92, and the length of wiring 92 is smaller than that of wiring 93. This configuration allows the inductance value generated by wiring 91, ground terminal 71, lead-out electrode 31, connecting electrode 51, and planar electrode 41 to be smaller than the inductance value generated by wiring 92, ground terminal 72, lead-out electrode 32, connecting electrode 52, and planar electrode 42. The inductance value generated by wiring 92, ground terminal 72, lead-out electrode 32, connecting electrode 52, and planar electrode 42 is smaller than the inductance value generated by wiring 93, ground terminal 73, lead-out electrode 33, connecting electrode 53, and planar electrode 43.

In the example described above, it has been described that the lengths of wirings 91-93 are changed to differentiate the inductance values generated by the wirings, ground terminals, lead-out electrodes, connecting electrodes, and planar electrodes; however, the present disclosure is not limited to this. For example, at least one of the length, width, and thickness of the wiring may be changed to differentiate the inductance value described above. Further, wirings 91-93 does not necessarily have straight line shapes, and may have meandering shapes.

Substrate module 80 thus includes printed-circuit board 90 and multilayer device 1A mounted on printed-circuit board 90. Printed-circuit board 90 includes ground electrode 99 and wirings 91, 92, and 93 connected to ground electrode 99. Wiring 91 is connected to ground terminal 71 of multilayer device 1A. Wiring 92 is connected to ground terminal 72 of multilayer device 1A. Wiring 93 is connected to ground terminal 73 of multilayer device 1A. Wirings 91, 92, and 93 have inductance values different from one another.

Substrate module 80 provides inductance values in accordance with wirings 91-93 on printed-circuit board 90 which are connected to ground terminals 70. The changing of the inductance values changes the values of the individual inductive component L50 generated by respective wirings 91-93 on printed-circuit board 90 and respective structures S1-S3 described above, thereby changing frequencies of the stopband of substrate module 80 including multilayer device 1A. This configuration provides the stopband in accordance with required specifications.

In the case that the same inductance values generated by the wirings, the ground terminals, the lead-out electrodes, the connecting electrodes, and the planar electrodes are provided, their wirings may have the same length to give the same inductance values.

### Modified Example 1 of Embodiment 1

Multilayer device 1B according to Modified Example 1 of Embodiment 1 will be described. In Modified Example 1, the height of ground terminals 70 is smaller than that of multilayer device 1B.

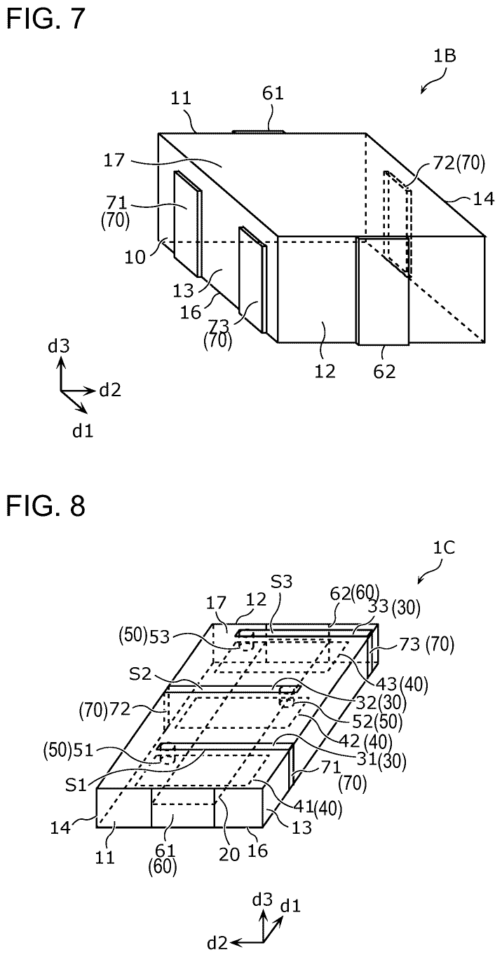

FIG. 7 is a perspective view of multilayer device 1B according to Modified Example 1 of Embodiment 1.

Multilayer device 1B shown in FIG. 7 includes dielectric body 10, signal line 20, planar electrodes 41, 42, and 43, connecting electrodes 51, 52, and 53, and lead-out electrodes 31, 32, and 33. Multilayer device 1B further includes signal terminals 61 and 62, and ground terminals 71, 72, and 73.

In multilayer device 1B according to Modified Example 1, the height of ground terminals 70 is smaller than that of multilayer device 1B. Ground terminals 70 contact bottom surface 16, and extend from bottom surface 16 along either side surface 13 or 14 toward the top surface 17, and do not reach top surface 17. Each of ground terminals 70 is connected to a corresponding one of lead-out electrodes 30 that is led out to either side surface 13 or 14 of dielectric body 10. The heights of ground terminals 70 may be equal to or different from one another.

Modified Example 1 also allows the values of individual inductive component L50 generated by both the respective wirings 91-93 on printed-circuit board 90 and the respective above-described structures S1-S3 to change to change the frequencies of the stopband of multilayer device 1B. This configuration allows the stopband to be provided in accordance with required specifications. Moreover, ground terminals 70 do not include any conductor on portions of side surfaces 13 and 14 connected to the top surface 17 to leaving areas where dielectric body 10 is exposed. This configuration allows appearance determination whether multilayer device 1B faces up or down. This enhances the mounting efficiency when mounting multilayer devices 1B on printed-circuit boards 90.

### Modified Example 2 of Embodiment 1

A configuration of multilayer device 1C according to Modified Example 2 of Embodiment 1 will be described. In Modified Example 2, the up-and-down relation of multilayer device 1A according to Embodiment 1 is reversed, and lead-out electrodes 30 are exposed from the outer surface of dielectric body 10.

FIG. 8 illustrates signal line 20, planar electrodes 41, 42, and 43, connecting electrodes 51, 52, and 53, lead-out electrodes 31, 32, and 33 of multilayer device 1C according to Modified Example 2 of Embodiment 1.

Multilayer device 1C shown in FIG. 8 includes dielectric body 10, signal line 20, planar electrodes 41, 42, and 43, connecting electrodes 51, 52, and 53, and lead-out electrodes 31, 32, and 33. Multilayer device 1C further includes signal terminals 61 and 62 and ground terminals 71, 72, and 73. In FIG. 8, illustrations of the thicknesses of signal terminals 61 and 62, and ground terminals 71, 72, and 73 are visually omitted from the figure.

Portions of dielectric body 10 are disposed between signal line 20 and each of lead-out electrodes 30 and planar electrodes 40. Further, dielectric body 10 covers planar electrodes 40, connecting electrodes 50, and the outer peripheral surface of signal line 20 except for both end surfaces thereof.

Signal line 20 has a straight strip shape, and is disposed along first direction d1. Signal line 20 according to Modified Example 2 is disposed closer to bottom surface 16 than planar electrodes 40.

Signal terminals 60 are disposed on side surfaces 11 and 12, portions of the outer surface of dielectric body 10. One end of signal line 20 is connected to one signal terminal 61 out of two signal terminals 61 and 62. Another end of signal line 20 is connected to the other signal terminal 62.

Planar electrodes 40 are disposed parallel to signal line 20. For example, planar electrode 41 is disposed inside dielectric body 10 such that planar electrode 41 is located between signal line 20 and lead-out electrode 31 in third direction d3. Planar electrode 42 is disposed inside dielectric body 10 such that planar electrode 42 is located between signal line 20 and lead-out electrode 32 in third direction d3. Planar electrode 43 is disposed inside dielectric body 10 such that planar electrode 43 is located between signal line 20 and lead-out electrode 33 in third direction d3.

Each of connecting electrodes 50 penetrates dielectric body 10 between a corresponding one of planar electrodes 40 and a corresponding one of lead-out electrodes 30, and connects corresponding planar electrode 40 to corresponding lead-out electrode 30. For example, connecting electrode 51 connects planar electrode 41 to lead-out electrode 31. Connecting electrode 52 connects planar electrode 42 to lead-out electrode 32. Connecting electrode 53 connects planar electrode 43 to lead-out electrode 33.

Lead-out electrodes 30 are wirings with strip shapes, and extend along second direction d2. Each of lead-out electrodes 30 is parallel to corresponding planar electrode 40 and disposed closer to top surface 17 than corresponding planar electrode 40. Lead-out electrodes 31, 32, and 33 are arranged in this order with regular intervals along first direction d1.

Lead-out electrodes 30 are disposed on top surface 17 of dielectric body 10, i.e., on the outer surface of dielectric body 10. For example, one end of lead-out electrode 31 is connected to connecting electrode 51 while another end of lead-out electrode 31 extends to side surface 13 of dielectric body 10. One end of lead-out electrode 32 is connected to connecting electrode 52 while another end of lead-out electrode 32 extends to side surface 14 of dielectric body 10. One end of lead-out electrode 33 is connected to connecting electrode 53 while another end of lead-out electrode 33 extends to side surface 13 of dielectric body 10. Each of lead-out electrodes 30 extends from a location close to one side surface out of two side surfaces 13 and 14 toward the other side surface, and is connected to a corresponding one of ground terminals 70 at another side surface of two side surfaces 13 and 14. In the above example, lead-out electrodes 30 are disposed on the outer surface of dielectric body 10; however, the present disclosure is not limited to this. Lead-out electrodes 30 may be embedded inside dielectric body 10.

Ground terminals 70 are disposed on the outer surface of dielectric body 10. Ground terminals 71 is connected to another end of lead-out electrode 31. Ground terminal 72 is connected to another end of lead-out electrode 32. Ground terminal 73 is connected to another end of lead-out electrode 33.

In Modified Example 2, planar electrodes 41, 42, and 43 are connected in one-to-one correspondence to connecting electrodes 51, 52, and 53. Connecting electrodes 51, 52, and 53 are connected in one-to-one correspondence to lead-out electrodes 31, 32, and 33. Lead-out electrodes 31, 32, and 33 are connected in one-to-one correspondence to ground terminals 71, 72, and 73. In other words, first structure S1 is composed of planar electrode 41, connecting electrode 51, lead-out electrode 31, and ground terminal 71. Second structure S2 is composed of planar electrode 42, connecting electrode 52, lead-out electrode 32, and ground terminal 72. Third structure S3 is composed of planar electrode 43, connecting electrode 53, lead-out electrode 33, and ground terminal 73. First structure S1, second structure S2, and third structure S3 are disconnected from one another and separated from one another.

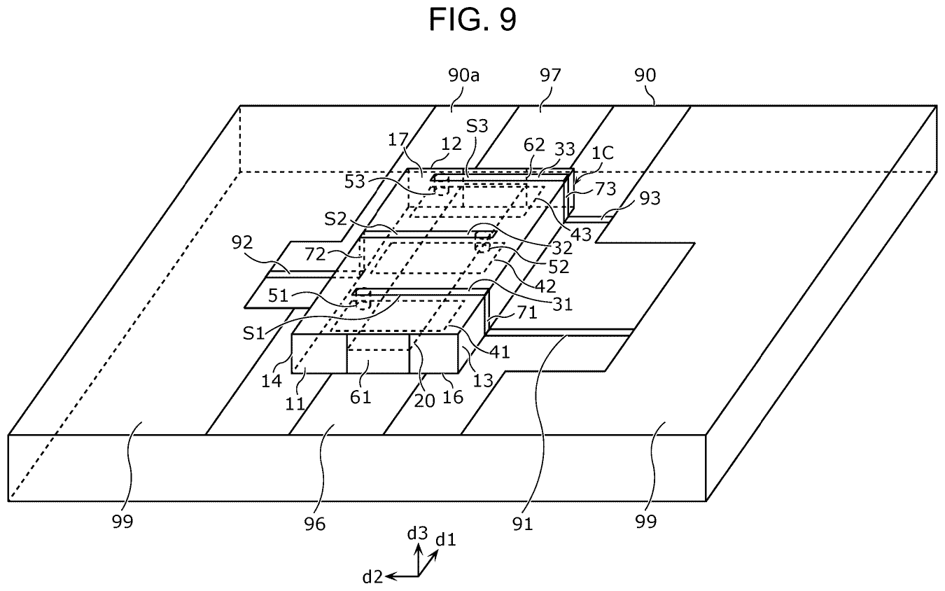

FIG. 9 illustrates substrate module 80 including multilayer device 1C.

Wirings 91-93 shown in FIG. 9 have the same width and thickness. Wirings 91-93 have lengths different from one another. In this example, the length of wiring 91 is larger than that of wiring 92. The length of wiring 92 is larger than that of wiring 93. This configurations causes the inductance value generated by wiring 91, ground terminal 71, lead-out electrode 31, connecting electrode 51, and planar electrode 41 to be larger than the inductance value generated by wiring 92, ground terminal 72, lead-out electrode 32, connecting electrode 52, and planar electrode 42. This configuration also causes the inductance value generated by wiring 92, ground terminal 72, lead-out electrode 32, connecting electrode 52, and planar electrode 42 to be larger than the inductance value generated by wiring 93, ground terminal 73, lead-out electrode 33, connecting electrode 53, and planar electrode 43.

In multilayer device 1C, a structure includes the planar electrode, the connecting electrode, the lead-out electrode, and the ground terminal. Plural structures S1-S3, are disconnected from one another and separated from one another both inside dielectric body 10 and on the outer surface of dielectric body 10. Therefore, as shown in FIG. 9, multilayer device 1C mounted on printed-circuit board 90 provides inductance values in accordance with wirings 91-93 on printed-circuit board 90 with the wirings being connected to ground terminals 70. For example, changing the inductance values changes the values individual inductive component L50 generated by each of the wirings 91-93 on printed-circuit board 90 and a respective one of the plural structures S1-S3, thereby changing frequencies of the stopband of substrate module 80 including multilayer device 1C. This configurations provides the stopband in accordance with required specifications.

### Modified Example 3 of Embodiment 1

Multilayer device 1D according to Modified Example 3 of Embodiment 1 will be described. In Modified Example 3, lead-out electrodes 30 have meandering shapes.

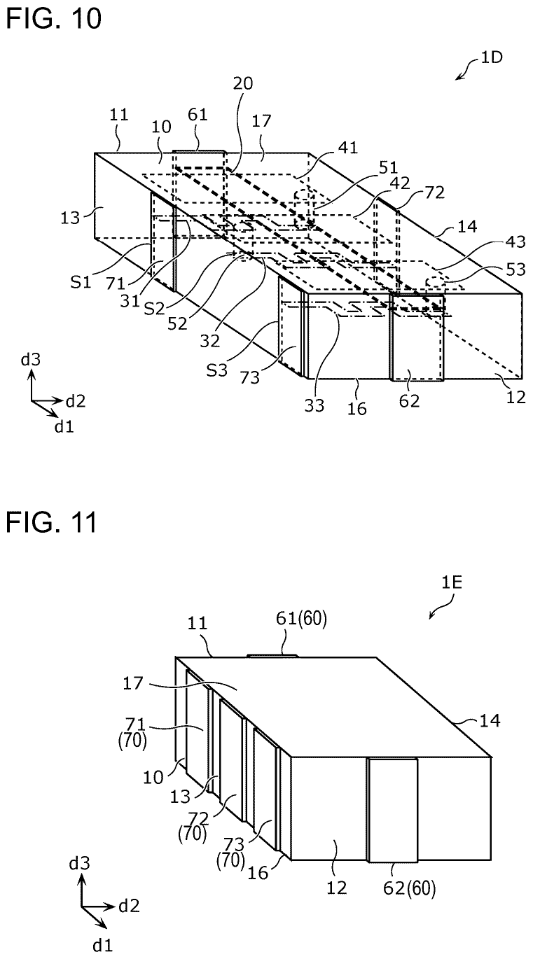

FIG. 10 illustrates signal line 20, planar electrodes 40, connecting electrodes 50, and lead-out electrodes 30 of multilayer device 1D according to Modified Example 3 of Embodiment 1.

Multilayer device 1D according to Modified Example 3 includes dielectric body 10, signal line 20, planar electrodes 41, 42, and 43, connecting electrodes 51, 52, and 53, and lead-out electrodes 31, 32, and 33. Multilayer device 1D further includes signal terminals 61 and 62 and ground terminals 71, 72, and 73. In FIG. 10, signal line 20 is indicated by a thick dashed line, and lead-out electrodes 31, 32, and 33 are indicated by dashed and dotted lines.

Configurations of dielectric body 10, signal line 20, planar electrodes 40, and connecting electrodes 50 according to Modified Example 3 are the same as those in Embodiment 1.

Each of lead-out electrodes 30 according to Modified Example 3 includes at least a part having a meandering shape. The meandering shape is a zig-zag shape. The meandering shape may extend along a waveform, such as a square wave, a triangular wave, a sinusoidal wave, or a circular arc wave.

Each lead-out electrode 30 is parallel to corresponding planar electrode 40 and disposed closer to bottom surface 16 than corresponding planar electrode 40. For example, one end of lead-out electrode 31 is connected to connecting electrode 51 while another end of lead-out electrode 31 contacts side surface 13 of dielectric body 10. One end of lead-out electrode 32 is connected to connecting electrode 52 while another end of lead-out electrode 32 contacts side surface 14 of dielectric body 10. One end of lead-out electrode 33 is connected to connecting electrode 53 while another end of lead-out electrode 33 contacts side surface 13 of dielectric body 10. Each lead-out electrode 30 extends from a location close to one side surface of two side surfaces 13 and 14 toward another side surface of two side surfaces 13 and 14, and is connected to a corresponding one of ground terminals 70 at another side surface of two side surfaces 13 and 14.

Modified Example 3 also includes a structure including the planar electrode, connecting electrode, lead-out electrode, and ground terminal. Plural structures S1-S3, are disconnected from one another and separated from one another both inside dielectric body 10 and on the outer surface of dielectric body 10. Therefore, multilayer device 1D mounted on printed-circuit board 90 provides inductance values in accordance with wirings 91-93 on printed-circuit board 90 with the wirings being connected to ground terminals 70. For example, changing the inductance values changes the values of individual inductive component L50 generated by both the respective wirings 91 to 93 on printed-circuit board 90 and the respective above-described plural structures S1-S3, thereby changing frequencies of the stopband of substrate module 80 including multilayer device 1D. This configuration provides the stopband in accordance with required specifications.

### Modified Example 4 of Embodiment 1

A configuration of multilayer device 1E according to Modified Example 4 of Embodiment 1 will be described. In Modified Example 4, connecting electrodes 50 have coil shapes.

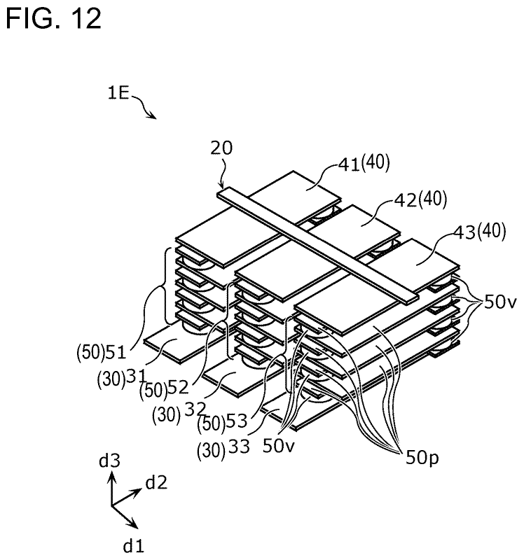

FIG. 11 is a perspective view of multilayer device 1E according to Modified Example 4 of Embodiment 1. FIG. 12 illustrates signal line 20, planar electrodes 40, connecting electrodes 50, and lead-out electrodes 30 of multilayer device 1E.

Multilayer device 1E shown in FIGS. 11 and 12 includes dielectric body 10, signal line 20, planar electrodes 41, 42, and 43, connecting electrodes 51, 52, and 53, and lead-out electrodes 31, 32, and 33. Multilayer device 1E further includes signal terminals 61 and 62 and ground terminals 71, 72, and 73. FIG. 12 illustrates multilayer device 1E except signal terminals 61 and 62, ground terminals 71, 72, and 73, and dielectric body 10 from multilayer device 1E.

Multilayer device 1E has the same configurations of dielectric body 10, signal line 20, planar electrodes 40, and signal terminals 60 as those in Embodiment 1.

At least a part of connecting electrodes 50 according to Modified Example 4 have a coil shape. Connecting electrode 50 shown in FIG. 12 have a rectangular-coil shape. The coil shape is not necessarily the rectangular shape, and may be a circular shape. Connecting electrode 50 includes via-electrodes 50v and one or more patterned electrodes 50p. Connecting electrode 50 shown in FIG. 12 includes seven patterned electrodes 50p and a 3.5-turn spiral-coil shape constituted by eight via-electrodes 50 v. Connecting electrode 50 does not necessarily have the spiral-coil shape, and may have a helical-coil shape.

Each of lead-out electrodes 30 is a wiring having a strip shape, and extends along second direction d2. Each lead-out electrode 30 is parallel to corresponding planar electrode 40 and disposed closer to bottom surface 16 than corresponding planar electrode 40. Lead-out electrodes 31, 32, and 33 are arranged in this order at regular intervals along first direction d1.

Lead-out electrodes 30 according to Modified Example 4 are disposed inside dielectric body 10 such that a part of lead-out electrode 30 is exposed from side surface 13, a part of the outer surface of dielectric body 10. Each of lead-out electrodes 31, 32, and 33 extends from a location close to one side surface 14 of two side surfaces 13 and 14 toward another side surface 13 of two side surfaces 13 and 14, and is connected to a corresponding one of ground terminals 70 at another side surface 13.

Ground terminals 71, 72, and 73 according to Modified Example 4 are disposed on side surface 13 out of four side surfaces 11-14. Ground terminals 71-73 are disposed on one side surface 13 different from side surfaces 11 and 12 on which signal terminals 60 is disposed. Ground terminal 71 is connected to another end of lead-out electrode 31. Ground terminal 72 is connected to another end of lead-out electrode 32. Ground terminal 73 is connected to another end of lead-out electrode 33.

Modified Example 4 also includes a structure that includes the planar electrode, the connecting electrode, the lead-out electrode, and the ground terminal. Plural structures S1-S3, are disconnected from one another and separated from one another both inside dielectric body 10 and on the outer surface of dielectric body 10. Therefore, multilayer device 1E mounted on printed-circuit board 90 provides inductance values in accordance with wirings 91-93 on printed-circuit board 90 with the wirings being connected to ground terminals 70. For example, changing the inductance values changes the values of individual inductive component L50 generated by the respective wirings 91-93 on printed-circuit board 90 and the respective structures S1-S3, thereby changing frequencies of the stopband of substrate module 80 including multilayer device 1E. This configuration provides the stopband in accordance with required specifications.

### Modified Example 5 of Embodiment 1

Multilayer device 1F according to Modified Example 5 of Embodiment 1 will be described. In Modified Example 5, signal line 20 has a meandering shape.

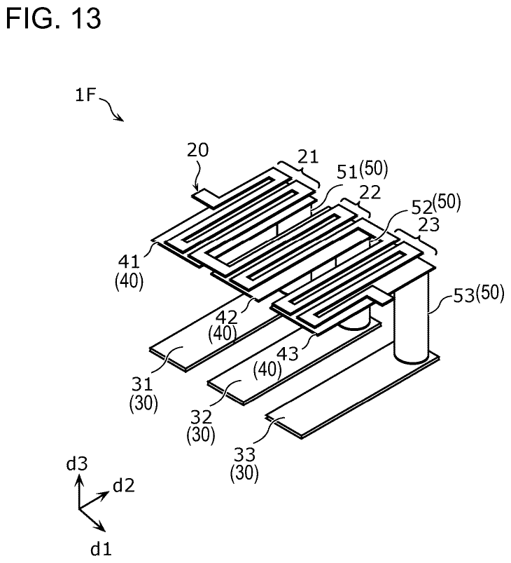

FIG. 13 illustrates signal line 20, planar electrodes 40, connecting electrodes 50, and lead-out electrodes 30. of multilayer device 1F according to Modified Example 5 of Embodiment 1.

Multilayer device 1F shown in FIG. 13 includes dielectric body 10, signal line 20, planar electrodes 41, 42, and 43, connecting electrodes 51, 52, and 53, and lead-out electrodes 31, 32, and 33. Multilayer device 1F further includes signal terminals 61 and 62 and ground terminals 71, 72, and 73 shown in FIG. 11.

Multilayer device 1F has the same configurations of dielectric body 10, planar electrodes 40, and signal terminals 60 as those in Embodiment 1. Multilayer device 1F has the same configurations of lead-out electrodes 30 and ground terminals 70 as those in Modified Example 4.

Signal line 20 according to Modified Example 5 includes at least a portion having a meandering shape. The meandering shape is a zig-zag shape. Signal line 20 shown in FIG. 13 has a meandering rectangular-wave shape. The meandering shape does not extend along the rectangular wave shape, and may extend another waveform, such as a triangular wave, a sinusoidal wave, or a circular arc wave. The meandering shape may be a pulse-wave meandering shape that is convex and concave along second direction d2.

Signal line 20 includes meandering portions 21, 22, and 23 having a meandering shape. Meandering portions 21, 22, and 23 are arranged in this order along first direction d1 from the input side to the output side of signal line 20. Signal line 20 is composed of meandering portions 21, 22, and 23 connected in series to one another.

Meandering portions 21, 22, and 23 are provided in one-to-one correspondence to planar electrodes 41, 42, and 43. That is, meandering portion 21 corresponds to planar electrodes 41, meandering portion 22 corresponds to planar electrodes 42, and meandering portion 23 corresponds to planar electrodes 43. In other words, meandering portions 21, 22, and 23 face planar electrodes 41, 42, and 43, respectively. That is, when viewed in third direction d3 perpendicular to planar electrodes 40, meandering portion 21 overlaps planar electrode 41, meandering portion 22 overlaps planar electrode 42, and meandering portion 23 overlaps planar electrode 43. Capacitive component C40 (see FIG. 2) of multilayer device 1F is generated in regions where meandering portions 21, 22, and 23 face planar electrodes 41, 42, and 43, respectively.

Lead-out electrode 30 is a wiring with a strip shape extending along second direction d2. Each lead-out electrode 30 is parallel to corresponding planar electrode 40 and disposed closer to bottom surface 16 than corresponding planar electrode 40. Lead-out electrodes 31, 32, and 33 are arranged in this order at regular intervals along first direction d1.

Lead-out electrode 30 according to Modified Example 5 is disposed inside dielectric body 10 such that a part of lead-out electrode 30 is exposed from side surface 13, a part of the outer surface of dielectric body 10. Each of lead-out electrodes 31, 32, and 33 extends from a location close to one side surface 14 of two side surfaces 13 and 14 toward the other side surface 13, and is connected to a corresponding one of ground terminals 70 at another side surface 13 of two side surfaces 13 and 14.

Ground terminals 71 to 73 are disposed on one side surface 13 different from side surfaces 11 and 12 on which signal terminals 60 is disposed. Ground terminal 71 is connected to another end of lead-out electrode 31. Ground terminal 72 is connected to another end of lead-out electrode 32. Ground terminal 73 is connected to another end of lead-out electrode 33.

Modified Example 5 also includes a structure that includes the planar electrode, the connecting electrode, the lead-out electrode, and the ground terminal. Plural structures S1-S3, are disconnected from one another and separated from one another both inside dielectric body 10 and on the outer surface of dielectric body 10. Therefore, multilayer device 1F mounted on printed-circuit board 90 provides inductance values in accordance with wirings 91-93 on printed-circuit board 90 with the wirings being connected to ground terminals 70. For example, changing the inductance values changes the values of individual inductive component L50 generated by both respective wirings 91-93 on printed-circuit board 90 and the respective plural structures S1-S3, thereby changing frequencies of the stopband of substrate module 80 including multilayer device 1F. This configuration provides the stopband in accordance with required specifications.

### Exemplary Embodiment 2

### Configuration of Multilayer Device

A configuration of multilayer device 1G according to Exemplary Embodiment 2 will be described. In accordance with Embodiment 2, multilayer device 1G will be described exemplarily as a common mode filter.

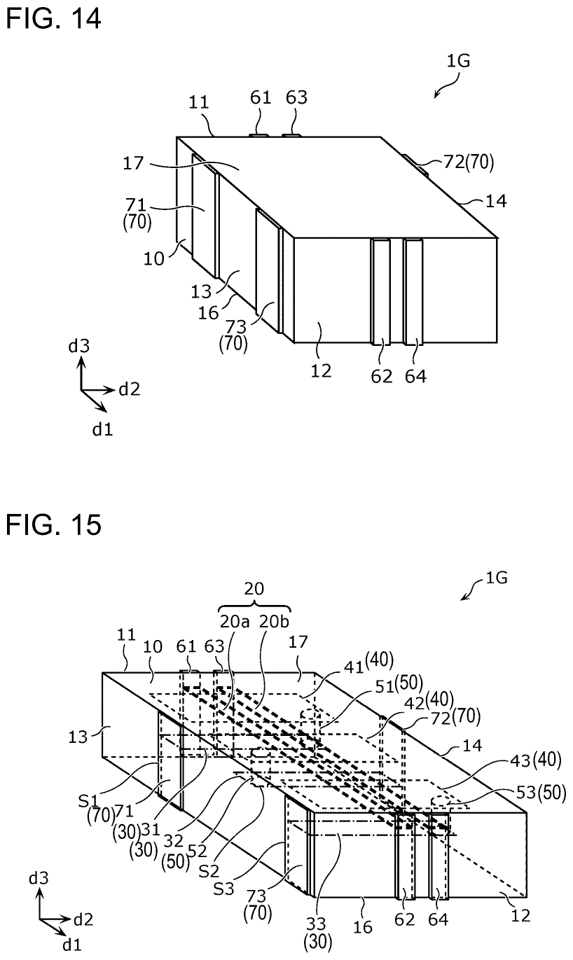

FIG. 14 is a perspective view of multilayer device 1G according to Embodiment 2. FIG. 15 illustrates signal line 20, planar electrodes 40, lead-out electrodes 30, and connecting electrodes 50 of multilayer device 1G.

Multilayer device 1G shown in FIGS. 14 and 15 includes dielectric body 10, signal line 20, planar electrodes 41, 42, and 43, connecting electrodes 51, 52, and 53, and lead-out electrodes 31, 32, and 33. Multilayer device 1G further includes signal terminals 61, 62, 63, and 64 and ground terminals 71, 72, and 73. In FIG. 15, signal line 20 is indicated by thick dashed lines, and lead-out electrodes 31, 32, and 33 are indicated by dashed and dotted lines.

Multilayer device 1G has the same configurations of dielectric body 10, planar electrodes 40, connecting electrodes 50, lead-out electrodes 30, and ground terminals 71-73 as those in embodiment 1.

Signal line 20 according to Embodiment 2 includes differential lines composed of two parallel signal lines 20a and 20b disposed inside dielectric body 10. Signal lines 20a and 20b have straight-line shapes extending along first direction d1. Signal lines 20a and 20b have strip shapes parallel to both planar electrodes 40 and lead-out electrodes 30. Multilayer device 1G mounted on substrate module 80 allows two parallel signal lines 20a and 20b to transmit differential signals.

Four signal terminals 61-64 are disposed on side surfaces 11 and 12 of dielectric body 10. One signal terminals 61 and 63 out of four signal terminals 61-64 are disposed on side surface 11 while another signal terminals 62 and 64 out of four signal terminals 61-64 are disposed on side surface 12. One end of signal line 20a is connected to one signal terminal 61. One end of signal line 20b is connected to one signal terminal 63. Another end of signal line 20a is connected to another signal terminal 62. Another end of signal line 20b is connected to another signal terminal 64.

The device also in accordance with Embodiment 2 includes a structure that includes the planar electrode, the connecting electrode, the lead-out electrode, and the ground terminal. Plural structures S1-S3, are disconnected from one another and separated from one another both inside dielectric body 10 and on the outer surface of dielectric body 10. Therefore, multilayer device 1G mounted on printed-circuit board 90 provides inductance values in accordance with wirings 91-93 on printed-circuit board 90 with the wirings being connected to ground terminals 70. For example, changing the inductance values changes the values of individual inductive component L50 generated by both respective wirings 91-93 on printed-circuit board 90 and the respective above-described plural structures S1-S3, thereby changing frequencies of the stopband of substrate module 80 including multilayer device 1G. This configuration provides the stopband in accordance with required specifications.

### SUMMARY

Multilayer device 1A (multilayer devices 1B-1G) according to the present embodiments includes: dielectric body 10; signal line 20 disposed inside dielectric body 10 such that a part of signal line 20 is exposed from an outer surface of dielectric body 10; a plurality of planar electrodes 40 disposed inside dielectric body 10 and along first direction d1; a plurality of lead-out electrodes 30 disposed either inside dielectric body 10 or on the outer surface of dielectric body 10 such that at least a part of the plurality of lead-out electrodes 30 is exposed from the outer surface of dielectric body 10; a plurality of connecting electrodes 50 disposed inside dielectric body 10 and connecting the plurality of planar electrodes 40 to the plurality of lead-out electrodes 30; a plurality of signal terminals 60 disposed on the outer surface of dielectric body 10 and connected to signal line 20; and a plurality of ground terminals 70 disposed on the outer surface of dielectric body 10 and connected to the plurality of lead-out electrodes 30. The plurality of ground terminals 70 is configured to have a ground potential. Structures S1-S3 each including a corresponding one of the planar electrodes, a corresponding one of the connecting electrodes, a corresponding one of the lead-out electrodes, and a corresponding one of the ground terminals are disconnected from one another and separated from one another both inside dielectric body 10 and on the outer surface of dielectric body 10.

Structures S1-S3 are thus disconnected to one another and separated from one another both inside dielectric body 10 and on the outer surface of dielectric body 10. Therefore, multilayer device 1A mounted on printed-circuit board 90 provides inductance values in accordance with wirings 91-93 on printed-circuit board 90 with the wirings being connected to ground terminals 70. For example, changing the inductance values changes the values of individual inductive component L50 (see FIG. 2) generated by respective wirings 91-93 on printed-circuit board 90 and the respective structures S1-S3, thereby changing frequencies of the stopband of substrate module 80 including multilayer device 1A. This configuration provides the stopband in accordance with required specifications. This configuration provides a broad stopband of multilayer device 1A by changing the values of individual inductive component L50 generated by the respective wirings 91-93 on printed-circuit board 90 and the respective structures S1-S3.

Further, the plurality of planar electrodes 40 may be connected in one-to-one correspondence to the plurality of connecting electrodes 50. The plurality of connecting electrodes 50 may be connected in one-to-one correspondence to the plurality of lead-out electrodes 30. The plurality of lead-out electrodes 30 may be connected in one-to-one correspondence to the plurality of ground terminals 70.

This configuration separates structures S1-S3 from one another both inside dielectric body 10 and on the outer surface of dielectric body 10 with each of the structures including the planar electrode, the connecting electrode, the lead-out electrode, and the ground terminal. Therefore, multilayer device 1A mounted on printed-circuit board 90 provides inductance values in accordance with wirings 91-93 on printed-circuit board 90 with the wirings being connected to ground terminals 70. For example, changing the inductance values changes the values of individual inductive component L50 generated by respective wirings 91-93 on printed-circuit board 90 and the respective structures S1-S3, thereby changing frequencies of the stopband of substrate module 80 including multilayer device 1A. This configuration provides the stopband in accordance with required specifications.

Lead-out electrodes 30 may be disposed inside dielectric body 10 such that a part of lead-out electrodes 30 is exposed from the outer surface of dielectric body 10. Ground terminals 70 may be connected to the part of lead-out electrodes 30 exposed from the outer surface of dielectric body 10.

Lead-out electrodes 30 disposed inside dielectric body 10 protects lead-out electrodes 30 from external environment.

Dielectric body 10 has bottom surface 16 parallel to planar electrodes 40, top surface 17 facing away from bottom surface 16, and four side surfaces 11, 12, 13, and 14 connected to bottom surface 16 and top surface 17. Ground terminals 70 may be disposed on two side surfaces 13 and 14 out of four side surfaces 11 to 14.

This configuration ensures inter-terminal distances between ground terminals 70. This facilitates mounting of multilayer device 1A on printed-circuit board 90.

Two side surfaces 13 and 14 may face away from each other.

This configuration increases the mounting reliability of multilayer device 1A on printed-circuit board 90 compared to ground terminals 70 disposed on side surfaces that do not face away from each other.

Lead-out electrode 30 may extend from a location close to one side surface (e.g., 14) of two side surfaces 13 and 14 toward another side surface (e.g., 13) of two side surfaces 13 and 14, and may be connected to the ground terminal at the another side surface (e.g., 13).

According to this configuration increases the length of lead-out electrode 30 compared to the case where lead-out electrode 30 extends from a location close to the other side surface 13 toward the other side surface 13. Therefore, the inductance value of structures S1-S3 that include lead-out electrode 30 is increased. Increasing the inductance value increases the value of inductive component L50, thereby lowering frequencies of the stopband of substrate module 80 including multilayer device 1A. This configuration provides the stopband in accordance with required specifications.

Two side surfaces 13 and 14 out of four side surfaces 11-14 may be different from side surfaces 11 and 12 on which the plurality of signal terminals 60 are disposed.

This configuration ensures inter-terminal distances between signal terminals 60 and ground terminals 70. This facilitates mounting of multilayer device 1A on printed-circuit board 90.

Each of connecting electrode 50 may be a via-conductor penetrating a portion of dielectric body 10 located between a corresponding one of the plurality of planar electrodes 40 and a corresponding one of the plurality of lead-out electrodes 30.

This configuration easily makes equal the inductance values of structures S1-S3 each including the connecting electrode. Therefore, substrate module 80 including multilayer device 1A easily has inductance values in accordance with wirings 91-93 on printed-circuit board 90 with the wirings being connected to ground terminals 70. This configuration allows the frequency of the stopband of substrate module 80 to be easily changed, thus providing the stopband in accordance with required specifications.

Connecting electrodes 50 may be configured such that, when viewed in a direction perpendicular to planar electrodes 40, the connecting electrodes do not overlap signal line 20 and overlap the outer peripheral end portions of planar electrodes 40.

This configuration allows connecting electrodes 50 to be disposed at the outer peripheral end portions of planar electrodes 40. This increases the overall length of each of the electrode structures composed of connecting electrodes 50 and planar electrodes 40, thereby increasing the inductance value of the electrode structure. Increasing the inductance value changes the value of inductive component L50, thereby lowering frequencies of the stopband of substrate module 80 including multilayer device 1A. This provides the stopband in accordance with required specifications.

Signal line 20 may include two parallel lines disposed in dielectric body 10.

This configuration allows multilayer device 1G to be used as a common mode filter.

The two parallel lines may constitute differential lines configured to transmit differential signals.

This configuration provides multilayer device 1G functioning as a common mode filter.

Multilayer device 1A (multilayer device 1B-1G) according to the present embodiments includes: dielectric body 10; signal line 20 disposed inside dielectric body 10 such that a part of signal line 20 is exposed from an outer surface of dielectric body 10; a plurality of planar electrodes 40 disposed inside dielectric body 10 and arranged along first direction d1; a plurality of lead-out electrodes 30 disposed either inside dielectric body 10 or on the outer surface of dielectric body 10 such that at least a part of the plurality of lead-out electrodes 30 is exposed from the outer surface of dielectric body 10; a plurality of connecting electrodes 50 disposed inside dielectric body 10; a plurality of signal terminals 60 disposed on the outer surface of dielectric body 10 and connected to signal line 20; and a plurality of ground terminals 70 disposed on the outer surface of dielectric body 10 and configured to have a ground potential. The plurality of planar electrodes 40 are connected in one-to-one correspondence to the plurality of connecting electrodes 50. The plurality of connecting electrodes 50 are connected in one-to-one correspondence to the plurality of lead-out electrodes 30. The plurality of lead-out electrodes 30 are connected in one-to-one correspondence to the plurality of ground terminals 70.

This configuration separates the structures each including a corresponding planar electrode, a corresponding connecting electrode, a corresponding lead-out electrode, and a corresponding ground terminal from one another both inside dielectric body 10 and on the outer surface of dielectric body 10. Therefore, multilayer device 1A mounted on printed-circuit board 90 provides inductance values in accordance with wirings 91-93 on printed-circuit board 90 with the wirings being connected to ground terminals 70. For example, changing the inductance values changes the values of individual inductive component L50 generated by respective wirings 91-93 on printed-circuit board 90 and the respective structures S1-S3, thereby changing frequencies of the stopband of substrate module 80 including multilayer device 1A. This configuration provides the stopband in accordance with required specifications.

Substrate module 80 according to the present embodiments includes multilayer device 1A (or multilayer device 1B-1G) described above.

Substrate module 80 provides a stopband in accordance with required specifications.

### Other Embodiments

Although the multilayer devices and the like according to the exemplary embodiments of the present disclosure and the variations thereof have been described so far, the present disclosure is not limited to the above embodiments and the variations thereof. Various modifications to the exemplary embodiments and variations thereof that may be conceived by those skilled in the art, as well as other embodiments resulting from combinations of some elements of the exemplary embodiments and variations thereof are intended to be included within the scope of the present disclosure as long as these do not depart from the essence of the present disclosure.

In the first embodiment, the example has been described in which three planar electrodes 41 to 43, three connecting electrodes 51 to 53, and three lead-out electrodes 31 to 33 are each disposed along first direction d1; however, the present disclosure is not limited to this. The number of structures each of which is composed of one planar electrode, one connecting electrode, and one lead-out electrode, either may be two or may be four or more. That is, the multilayer device may have a configuration in which four or more planar electrodes, four or more connecting electrodes, and four or more lead-out electrodes may be arranged along first direction d1. In this case, four or more ground terminals may be disposed in the multilayer device.

### INDUSTRIAL APPLICABILITY

A multilayer devices according to the present disclosure are useful as multilayer devices for various electronic appliances and communication systems.

### REFERENCE MARKS IN THE DRAWINGS

1, 1A, 1B, 1C, 1D, 1E, 1F, 1G multilayer device
10 dielectric body
11, 12, 13, 14 side surface
16 bottom surface
17 top surface
20, 20a, 20b signal line
21, 22, 23 meandering portion
30, 31, 32, 33 lead-out electrode
40, 41, 42, 43 planar electrode
50, 51, 52, 53 connecting electrode
50p patterned electrode
50v via-electrode
60, 61, 62, 63, 64 signal terminal
70, 71, 72, 73 ground terminal
80 substrate module
90 printed-circuit board
90a mounting surface
91, 92, 93, 96, 97 wiring
99 ground electrode
d1 first direction
d2 second direction
d3 third direction
S1, S2, S3 structure

1. A multilayer device, comprising:
a dielectric body;
a signal line disposed inside the dielectric body such that a part of the signal line is exposed from an outer surface of the dielectric body;
a plurality of planar electrodes disposed inside the dielectric body and along a first direction;
a plurality of lead-out electrodes disposed either inside the dielectric body or on the outer surface of the dielectric body, at least a part of the plurality of lead-out electrodes being exposed from the outer surface of the dielectric body;
a plurality of connecting electrodes disposed inside the dielectric body and connecting the plurality of planar electrodes to the plurality of lead-out electrodes;
a plurality of signal terminals disposed on the outer surface of the dielectric body and connected to the signal line; and
a plurality of ground terminals disposed on the outer surface of the dielectric body and connected to the plurality of lead-out electrodes, the plurality of ground terminals being configured to have a ground potential, wherein
the plurality of planar electrodes, the plurality of connecting electrodes, the plurality of lead-out electrodes, and the plurality of ground terminals constitute a plurality of structures,
each of the plurality of structures includes a corresponding one planar electrode out of the plurality of planar electrodes, a corresponding one connecting electrode out of the plurality of connecting electrodes, a corresponding one lead-out electrode out of the plurality of lead-out electrodes, and a corresponding one ground terminal out of the plurality of ground terminals, and
the plurality of structures are disconnected from one another and separated from one another both inside the dielectric body and on the outer surface of the dielectric body.

2. The multilayer device according to claim 1, wherein
the plurality of planar electrodes are connected in one-to-one correspondence to the plurality of connecting electrodes, such that each of the plurality of planar electrodes is connected to a corresponding one of the plurality of connecting electrodes,
the plurality of connecting electrodes are connected in one-to-one correspondence to the plurality of lead-out electrodes, such that each of the plurality of connecting electrodes is a corresponding one of the plurality of lead-out electrodes, and
the plurality of lead-out electrodes are connected in one-to-one correspondence to the plurality of ground terminals, such that each of the plurality of lead-out electrodes is connected a corresponding one of the plurality of ground terminals.

3. The multilayer device according to claim 1, wherein
the plurality of lead-out electrodes are disposed inside the dielectric body such that a part of the plurality of lead-out electrodes is exposed from the outer surface of the dielectric body, and
each of the plurality of ground terminals is connected to the part of the each of the plurality of lead-out electrodes, the part being exposed from the outer surface of the dielectric body.

4. The multilayer device according to claim 1, wherein
the dielectric body has a bottom surface parallel to the plurality of planar electrodes, a top surface facing away from the bottom surface, and four side surfaces connected to the bottom surface and the top surface, and
the plurality of ground terminals are disposed on two side surfaces out of the four side surfaces.

5. The multilayer device according to claim 4, wherein the two side surfaces face away from each other.

6. The multilayer device according to claim 5, wherein the plurality of lead-out electrodes extend from positions close to one side surface out of the two side surfaces toward another side surface out of the two side surfaces, and are connected to the plurality of ground terminals at the another side surface.

7. The multilayer device according to claim 5, wherein the two side surfaces are different from a side surface out of the four side surfaces which has the plurality of signal terminals is disposed thereon.

8. The multilayer device according to claim 1, wherein each of the plurality of connecting electrodes is a via conductor penetrating a portion of the dielectric body located between a corresponding one of the plurality of planar electrodes and a corresponding one of the plurality of lead-out electrodes.

9. The multilayer device according to claim 8, wherein the plurality of connecting electrodes do not overlap the signal line when viewed in a direction perpendicular to the plurality of planar electrodes, and each of the plurality of connecting electrodes overlaps an outer peripheral end portion of a corresponding one of the plurality of planar electrodes when viewed in the direction perpendicular to the plurality of planar electrodes.

10. The multilayer device according to claim 1, wherein the signal line includes two parallel lines disposed in the dielectric body.

11. The multilayer device according to claim 10, wherein the two parallel lines are differential lines configured to transmit differential signals.

12. A multilayer device comprising:
a dielectric body;
a signal line disposed inside the dielectric body such that a part of the signal line is exposed from an outer surface of the dielectric body;
a plurality of planar electrodes disposed inside the dielectric body and along a direction;
a plurality of lead-out electrodes disposed either inside the dielectric body or on the outer surface of the dielectric body, at least a part of each of the plurality of lead-out electrodes being exposed from the outer surface of the dielectric body;
a plurality of connecting electrodes disposed inside the dielectric body;
a plurality of signal terminals disposed on the outer surface of the dielectric body and connected to the signal line; and
a plurality of ground terminals disposed on the outer surface of the dielectric body and configured to have a ground potential, wherein
the plurality of planar electrodes are connected in one-to-one correspondence to the plurality of connecting electrodes,
the plurality of connecting electrodes are connected in one-to-one correspondence to the plurality of lead-out electrodes, and
the plurality of lead-out electrodes are connected in one-to-one correspondence to the plurality of ground terminals.

13. A substrate module comprising the multilayer device according to claim 1.
